(19) United States
(12) Patent Application Publication
(10) Pub. No.: US 2017/0178064 A1
(43) Pub. Date: Jun. 22, 2017

(54) LOCATION-AWARE INFORMATION SYSTEM AND METHOD

(71) Applicant: Action Innovative Solutions Sp. z o.o., Bielsko-Biala (PL)

(72) Inventor: Piotr Olejak, Bielsko Biala (PL)

(21) Appl. No.: 15/382,330

(22) Filed: Dec. 16, 2016

Related U.S. Application Data
(60) Provisional application No. 62/305,095, filed on Mar. 8, 2016.
(60) Provisional application No. 62/268,399, filed on Dec. 16, 2015.

(51) Int. Cl. G06Q 10/08; G08B 21/24; G06K 7/10

(52) U.S. Cl. CPC G06Q 10/087; G06K 7/10128; G06K 7/10405; G08B 21/24; H04L 67/12

(57) ABSTRACT

A system for exchanging location-aware information is described. It includes a server having a data store and an analytical engine. It also includes one or more transmission point in communication with the server. Further the system includes at least one beacon in communication with the transmission point. Each item beacon includes a means to determine the location. Results of the system are conveyed using at least one end user device, which is in communication with said server and displays information about item beacons received from the transmission point.

### PRIORITY

This Utility patent application claims the benefit of U.S. Provisional Patent Application No. 62/305,095 filed on Mar. 8, 2016 and U.S. Provisional Patent Application No. 62/268,399, filed on Dec. 16, 2015, both incorporated in their entirety by reference.

### BACKGROUND OF THE INVENTION

1. Field of the Invention

The field of the invention is an item location tracking device and method of use of same to prevent thefts or misplacement of items.

2. Background of the Invention

In various embodiments, the invention provides a turnkey system for person and item tracking allowing for verifying item location as well as relaying information to end users.

In one embodiment, the invention comprises a central server, a mobile application, at least one point station for sending and receiving of information, and one or more item beacons. The point station relaying signals received from item tracking beacons and sends them to the server, which in turn processes the information into an end-user presentation which is conveyed to the end user via a mobile application.

Traditionally, tracking of items is done manually or with a single item tracking device, such as a RFID tag. The end user must manage the RFID tag and depending on the overhead of the system, can retrieve information about the location of the tagged item. Prior art systems are capable of only one-way communication and while they may support location determination, they do not provide additional information nor do they allow for two-way communication.

A need exists in the art for a system that allows for tracking of many items, is expandable, can be used in conjunction with many different processes, and employs reliable communication means with little to no lag time.

### SUMMARY OF INVENTION

An object of the invention is to create a system for tracking of assets. An advantage of the invention is that it allows for tracking of physical assets using wireless location tags. An advantage of the invention is that it prevents loss or theft.

Another object of the invention is to allow for an exchange of information between tracked assets and the system end user. A feature of the invention is that two-way communication is established between the tagged assets and a transmission point. An advantage of the invention is that it allows end users to collect and process information about tracked items.

A further object of the invention is to provide a system for tracking many physical properties of a tracked item. A feature of the invention is that many different types of sensors and items may be simultaneously tracked by the system. An advantage of the invention is that it allows the end user to incorporate many different sensors and select many different types of beacons for use as necessary in a given project.

An object of the invention is to provide a means to exchange information with a user on the basis of the user's location. A feature of the invention is that the end-user application will send various messages to the user upon encountering the signal of a particular beacon. An advantage of the invention is that it can transmit location-aware messages to an end-user without requiring the user sharing a location or using energy intensive location determination.

Yet another object of the invention is to provide a tracking system that can monitor transport, loading, and unloading of delivery items. A feature of the invention is that the transmission point is portable and incorporates cellular transmission antennae. An advantage of one embodiment is that it can be used on a moving vehicle to track the progress of delivery of high-value items.

A further object of the invention is to provide a system for alerting of third parties if a tracked item moves unexpectedly. A feature of the invention is that the transmission point is in close and frequent communication with item tracking beacons and notifies the system of any unexpected movements. A benefit of the system is that it acts as a deterrent against unauthorized movement of items.

Another object of the invention is to provide a system for incorporating business processes into tracking processes. A feature of the invention is that the end user may add business process information into the tracking feature to verify compliance with applicable regulations or workplace rules. A benefit of the system is that a large number of beacon sensors may be used in concert to ensure that end-user requirements for item movement are followed.

An additional object of the invention is to support obtaining many different readings from one beacon tracking tag. A feature of the invention is that a beacon tag may contain many different sensors, such as mems sensors for determining acceleration, gravity, temperature, humidity, and others. A benefit of the system is that the system processes a large number of data points in order to arrive at actionable alerts and transmits same to the end user.

A further object of the invention is to provide a system which can incorporate many end-user devices. A feature of the system is that in one embodiment the transmission point uses Bluetooth low energy transmissions to communicate with item beacons. A benefit of the system is that it allows for incorporation of many different devices for tracking of items and other system features, such as changing behavior smart home devices.

An additional object of the invention is to provide a means to facilitate sharing of high-value assets. A feature of the invention is that the location and other physical properties of a high-value device are known in real-time allowing for sharing of the asset with less risk. A benefit of the invention is that in some embodiments, the system supports item location and sharing.

A further object of the invention is to provide a system for analysis of large quantities of data. A feature of the system is that one or more item tracking beacons interact with transmission points which forward data to a central server. A benefit of the system is that the central server filters the data and turns it into actionable information for the end user.

A system for exchanging location-aware information comprising: a server having a data store and an analytical engine; at least one transmission point in communication with said server; at least item beacon in communication with at least one transmission point wherein said item beacon includes a means to determine the location of said beacon; and at least one end user device wherein said end user device is in communication with said server and displays information about item beacons received from the at least one transmission point.

### BRIEF DESCRIPTION OF DRAWING

The invention together with the above and other objects and advantages will be best understood from the following detailed description of the preferred embodiment of the invention shown in the accompanying drawings, wherein:

FIG. 1 depicts an overview of the system pursuant to one embodiment of the invention;

FIG. 2 depicts an overview of an embodiment of the transmission point of an invention;

FIG. 3 depicts an overview of an alternate embodiment of the transmission point of an invention;

FIGS. 4A-B depict an overview of an additional alternate embodiment of the transmission point of an invention;

FIG. 5A depicts an overview of a location-aware information exchange system pursuant to one embodiment of the invention;

FIGS. 5B-C depict an embodiment of the invention showing use of the geolocation features;

FIG. 6 depicts an overview of an alarm system pursuant to one embodiment of the invention;

FIGS. 7A-H depict one embodiment of the invention;

FIGS. 8A-C depict an alternative embodiment of the invention;

FIGS. 9A-B depict the alternative embodiment of FIGS. 8A-C in an environment;

FIG. 10 depicts a detailed view of an embodiment of a component of the system;

FIGS. 11A-D depict a deployment of one alternative embodiment of the system;

FIGS. 12A-D depict a deployment of an alternative embodiment of the system;

FIGS. 13A-D depict a deployment of another alternative embodiment of the system; and

FIG. 14 depicts a detailed view of a transport container pursuant to an embodiment of the system.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

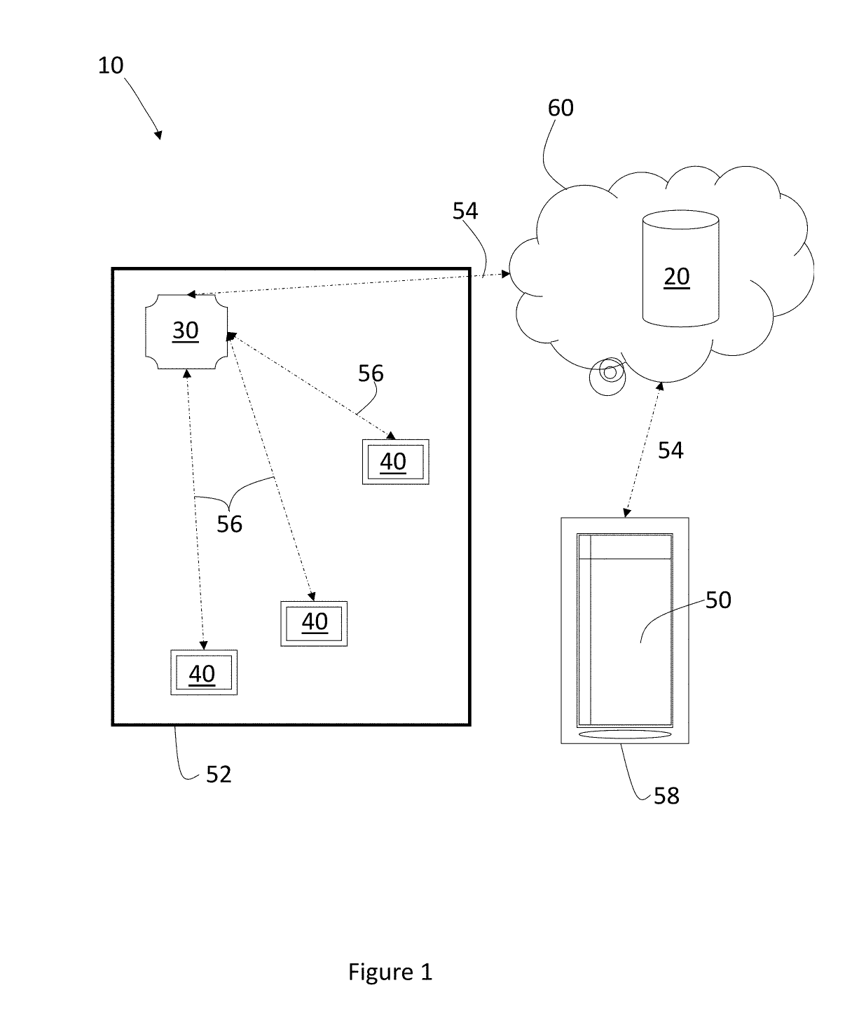

Turning to the figures, in FIG. 1 depicted therein is an overview 10 of the invented system. The system comprises a server 20, one or more transmission points 30. The transmission point 30 is in communication with one or more item beacons 40. In the embodiment shown in FIG. 1 and for clarity, one transmission point 30 is depicted. However, the system 10 can support multiple transmission points 30, including ones that communicate with one another forming a local transmission point network. In one embodiment, the primary mode of operation for the system is wireless communication between the sensors and a base station, as well as sensors individually. Further, FIG. 1 depicts three item beacons 40, however, the system can support a large number of beacons, with one transmission point capable of communicating with as many beacons as can be supported on the chosen wireless medium.

In one embodiment, the system is capable of communicating with 250 item beacons 40 to each transmission point 30. This embodiment relies on Bluetooth communications. In another embodiment, each beacon 40 communicates using a low-power wide area network, such as one pursuant to the LoRaWAN specification. In this embodiment of the system, up to 10,000 beacons can communicate with each transmission point 30.

Throughout this description, the system is described as interacting with beacons as client devices. While specific implementations of beacons are described, including low power Bluetooth wireless interfaces, it should be understood that the system can communicate using any number of wireless protocols, and not all client devices will be typical beacons. As will be described below, most beacons comprise sensors coupled with low power wireless network interface. However, the system is not limited to wireless sensors or single-purpose sensors. As is described herein, the system also includes support for third-party solutions.

In the embodiment shown in FIG. 1, the beacons 40 are located inside of a physical location 52. In one embodiment, the system 10 allows for the definition of a physical location 52 on the basis of a building or sub-parts of a building (such as a store room in a hospital or a particular section of a warehouse). In another embodiment, the system allows for the definition of a physical location 52 not bounded by physical walls, such as defined by signal reach or other physical dimensions, such as boundaries of a park. In one embodiment, the system 10 allows the end user to define one or more logical locations within the physical location 52, such as ingress/egress means and areas where the beacons 40 should not be brought into. In one embodiment, the system 10 alerts security staff if beacons 52 attached to inventory for sale are in the process of being taken off the shop floor without first passing through the checkout area.

In this embodiment, the system 10 maintains a history of the location of each beacon 40. The history includes a current relative location to each transmission point 30, as well as an extrapolated geo-location within a physical location 52. In one embodiment, the history further includes an indication of detected motion, including the direction and magnitude of the motion. In one embodiments, the beacons 40 are interrogated several times per second, or approximately every 333 Milliseconds. In another embodiment, each beacon 40 broadcasts its location and speed, rather than waiting to be interrogated about location and/or velocity. This broadcast model is especially suitable for embodiments using the distributed low-power wide area network communications.

The beacons 40 are in wireless communications with the transmission point 30 using beacon wireless communication signals 56. In one embodiment, the wireless communication signals comprise low energy Bluetooth or other wireless signals. In one embodiment, the beacon wireless communication signals 56 are encrypted. A benefit of using a standards-based system such as Bluetooth Low Energy (le) is that many different types of item beacons 40 may be combined into a single installation, including item beacons 40 from different manufacturers having different types of sensors.

An advantage of the system 10 is that it offers an open architecture for sensors acting as beacons 40 or for sensors which can be added to standard beacons 40. In one embodiment, part of the system 10 is a physically extendable beacon 40, to which third-party sensors are mounted and initialized. In this manner, the extensible beacon 40 can be used to deploy sensors with varying sensitivities and granularities. For example, a temperature sensor which is accurate to changes of 0.1 of a degree may be unnecessary for a measurement of temperatures on a factory floor setting, but such sensors are frequently required for individual processes, such as chemical reactions. As the system 10 offers expandable beacons, it allows for customization of sensors, depending on the practical application being measured.

In the embodiment shown in FIG. 1, the beacon wireless communications 56 employ two-way communication between each beacon 40 and the transmission point 30.

In one embodiment, a variety of item beacons 40 are used with the system 10. The item beacons 40 employ a number of sensors, including sensors using MEMS technology, including ones that monitor acceleration, detect changes in the force of gravity, temperature, humidity, and others. Each item beacon 40 is attached to an item to be tracked or placed in an area of interest, such as monitoring temperature and humidity in proximity to sensitive equipment.

In one embodiment, item beacons 40 employ a hybrid power source, including a main power source and a backup battery. For example, one variety of beacon 40 employs both a rechargeable battery as well as solar cells to recharge the battery or operate in a lower-power mode if the battery runs too low.

In one embodiment, the beacons 40 form a mesh network between one another as well as any transmission points 30. This allows the mesh network to be configured and installed in locations where some of the beacons 40 are out of range of the transmission point 30, but can communicate with the transmission point 30 indirectly by using other beacons 40. In this mesh embodiment, the system tracks which beacon 40 has an active connection to a transmission point 30. The beacons 40 not in communication with a transmission point 30 transmit data until such a beacon is detected. In this case, the path to that connected beacon is shared between all beacons or sensors not in direct communication with an active transmission point 30. In this way, the beacons 40 or sensors form a dynamic mesh, sharing a routing table of possible hops to an active beacon 40.

In one embodiment, the beacons 40 are attached to items located in a house or office. In another embodiment, the beacons 40 are used in conjunction with industrial equipment. In yet another embodiment, the beacons 40 are used in transport systems, such as road vehicles, elements of the rail infrastructure. In a further embodiment, the beacons 40 are used in conjunction with people and animals. In other embodiments, the beacons 40 are used in conjunction with transportation means, such as bicycles, motorcycles, cars, trucks, airplanes, and others.

As described more fully below, the beacons 40 are designed to be mobile, and the beacons 40 incorporate both geo-location and triangulation to determine their relative locations to the base stations or transmission points 30. In at least one embodiment, described below, the system is used in conjunction with elements moving in 3-dimensional space, incorporating a drone into the environment.

The transmission point 30 includes several wireless transmission systems, in one embodiment, as well as other network connectivity. The transmission point 30 is in wireless communication with the beacons 40 using the aforementioned beacon wireless communication 56. Information from the transmission point 30 is sent over the server communication system 54. In the embodiment shown in FIG. 1, the server communication system 54 comprises a connection to a multi-user network 60, such as the Internet. However, in some embodiments, the server 20 is located on the same network as the transmission point 30. In those embodiments, the communication with the multi-user network 60 is unnecessary and instead the server communication system 54 is a direct connection to the server 20. The server communication system 54 comprises a wired connection, such as an Ethernet connection, or a serial connection, in some embodiments.

While in FIG. 1 a single server 20 is depicted, in other embodiments many servers are employed to process and analyze the data. The data sets generated by the system 10 are significant, in some embodiments, as each of thousands of sensors or beacons 40 will generate several readings per second. As such, to prevent overloading of a single server 20, multiple servers are employed, in one embodiment, with load balancing enforced between the servers. In another embodiment, the server 20 is a service spanning multiple distributed computers using a cloud-computing paradigm.

In most embodiments, the server communication system 54 comprises a wireless connection. In one embodiment, the server communication system 54 within the transmission point 30 employs a cellular or GSM connection. In another embodiment, the server communication system 54 comprises a wifi connection. In a further embodiment, the server communication system 54 uses a satellite connection. In some embodiments, the server 20 also includes a means to communicate with individual beacons 40, such as the distributed wide area network connection, including Sigfox or LoRa WAN.

The server 20 is depicted as a data store in FIG. 1, but the server 20 acts as both a data store and a data processing device, in one embodiment. The server 20 collects data from the transmission point 30 and assembles same into an end-user presentation.

The analytical software on the server 20 creates containers of data for the end-user application 50, in one embodiment. Only selected containers are transmitted to the end-user application 50, and the end-user application 50 provides means to select which data is to be transmitted, in one embodiment. In this way, the server 20 provides a means to analyze data but also be a source of big data sets. The big data found on the server 20 provides an excellent source of historical information about beacon 40 behavior. The data may be shared for business function decisions, or to optimize marketing efforts.

In one embodiment, the system 10 provides a number data sets suitable for marketing purposes. One data set of an embodiment includes identifying clients of a retail establishment, their movement within a premises. The data includes time spent browsing the merchandise, time spent in the parking area, and intended purchases. The system 10 can be used to provide clients with information about discounts, promotions, and to enable payment for parking, or validation of parking. The system 10 can provides information for purposes of public safety, including informing parties present at a location about an evacuation order, fire alarm, and indicating the path to the nearest exit.

In one embodiment, with strategically placed beacons 40, local authorities can use the big data sets to make decisions about traffic, air quality, or areas most frequently visited by residents or tourists.

The system 10 also includes an end-user application 50 used on a computing device 58. The end-user application 50, communicates with the server 20, in one embodiment using the server communication 54. In one embodiment, the end-user application 50 both sends and receives information to the server 20. The connection with the server 20 and the end-user application 50 is intermittent. As such, while the end-user application 50 is not active, the server 20 continues to gather and process information from the transmission point 30.

The end-user application 50 may be used on any computing device 58 which has a connection 54 to the server. The computing device 58 requires only an output means, such as a screen, and an input means, such as a touchscreen. The computing device 58 does not require any location-determination technology, such as GPS antennas.

In summary, the system 10 provides reporting and other functions into an application 50 which interacts with the server 20. The server 20, in turn, obtains data from the transmission point 30. The transmission point 30 obtains raw data from the beacons 40. Communication with the beacons 40 is handled using BLE Bluetooth 4.0 and similar technologies. The system 10 also supports wifi, with some beacons 40 and other system elements incorporating GPS receivers and other radio communication means.

### Transmission Point Embodiments

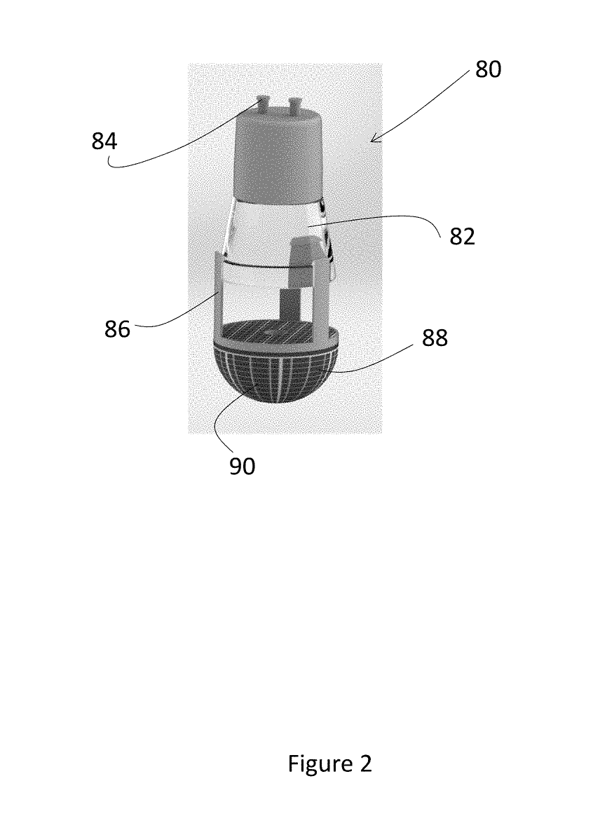

Turning to FIG. 2, depicted therein is a light socket embodiment 80 of the transmission point 30. The light socket embodiment 80 comprises a standard bulb having a light lens 82 and socket pins 84. The light socket embodiment 80 comprises three tabs 86 which attach the transmission module 90 to the bulb light 82. The transmission module 90 contains the wireless transmission means of the light socket embodiment 80 as well as cache memory and basic processing for data handling. The module 90 collects the data from the beacons and transmits it to the server. The module 90, as shown in FIG. 2, is covered by solar panels 88 as well as a light detector. As such, the module 90 can operate without directly connecting the module 90 to a power source. Instead relies on a light 82 and adjacent sources of natural or artificial light, as the solar panels 88 cover substantially the entire exterior surface of the module 90.

A benefit of the light socket embodiment 80 is that it can be installed in a ceiling-mounted fixture which results in the module 90 and associated wireless communication having long range. The light socket embodiment 80 can be placed high off the ground where it will not be tampered with. While the light socket embodiment 80 requires a light source, the module 90 is removably attached to the light lens 82. As such, it does not require modification of the light bulb and can be added or removed as needed when the light 82 no longer operates. Additionally, the light socket embodiment 80 does not require all of the light output of the light lens 82. As such, the light lens 82 will continue to add light to the premises, even though it will be somewhat obscured by the module 90.

In one version of the light socket embodiment 80, a battery is charged while the light is switched on. After the battery is fully charged, no additional energy is drawn from the light socket, and any additional energy generated from solar cells is used to trickle-charge the battery.

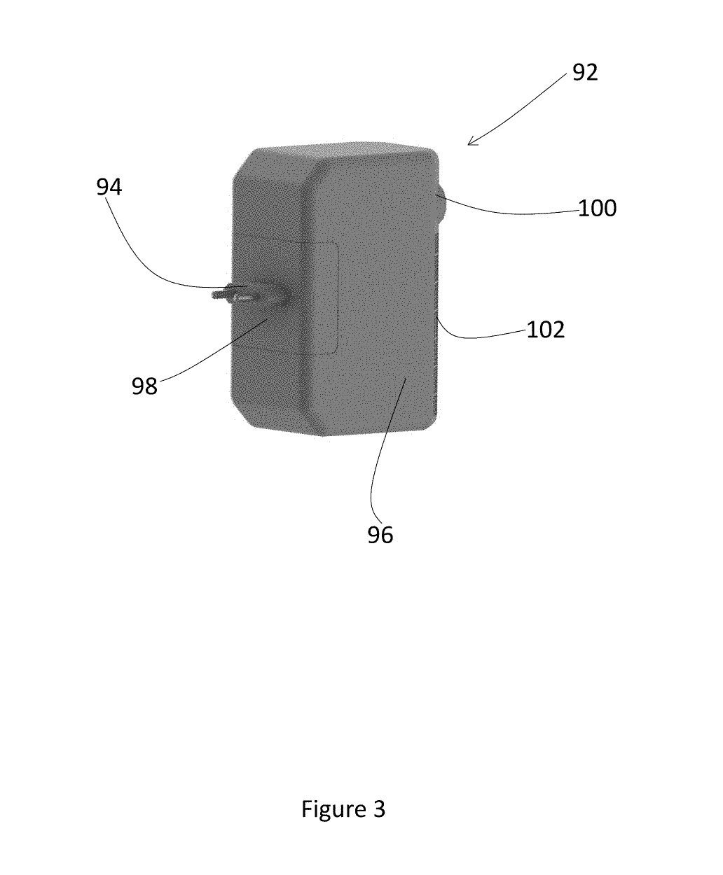

Turning to FIG. 3, a plug-in embodiment 92 is depicted therein. The plug-in embodiment 92 includes a plug 94 to an electrical outlet. In one embodiment the plug 94 is attached to the transmission module 96 using a removable component 98. In this embodiment, different types of plugs 94 may be accommodated, such as a plug for Europe (as shown) versus a North American plug, or a 12V DC plug adapter for use in a vehicle.

The transmission module 96 incorporates a number of sensors, such as a motion or light sensor 100 on the surface of the module 96. Further, while the primary source of power for the module 96 is the plug 94, the module 96 also incorporates one or more back up power sources such as solar panels 102. By providing secondary power sources, the module 96 may raise an alarm if it loses the main power source or is moved out of the outlet.

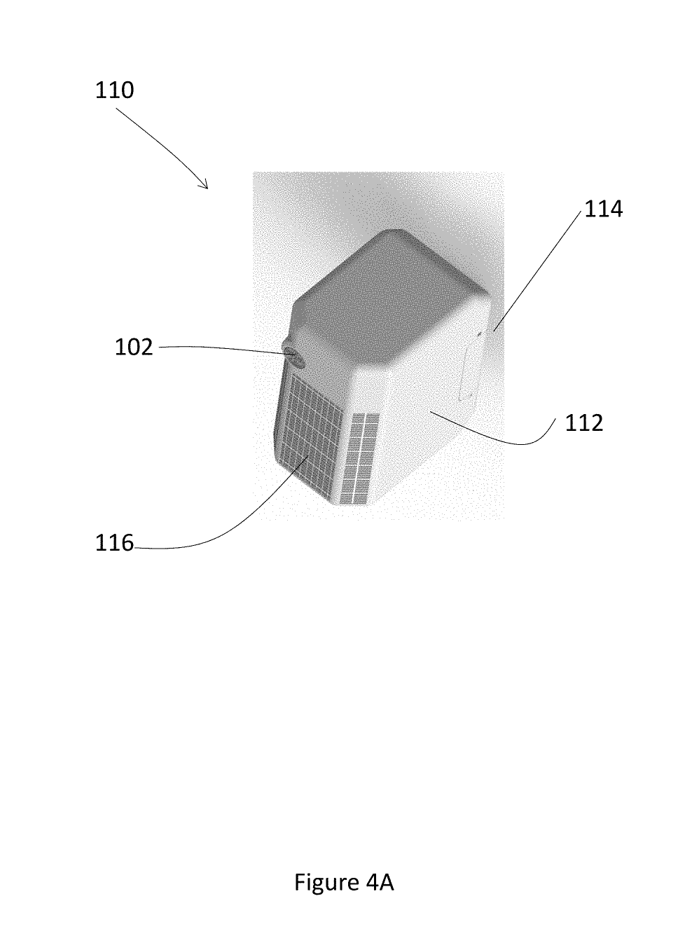

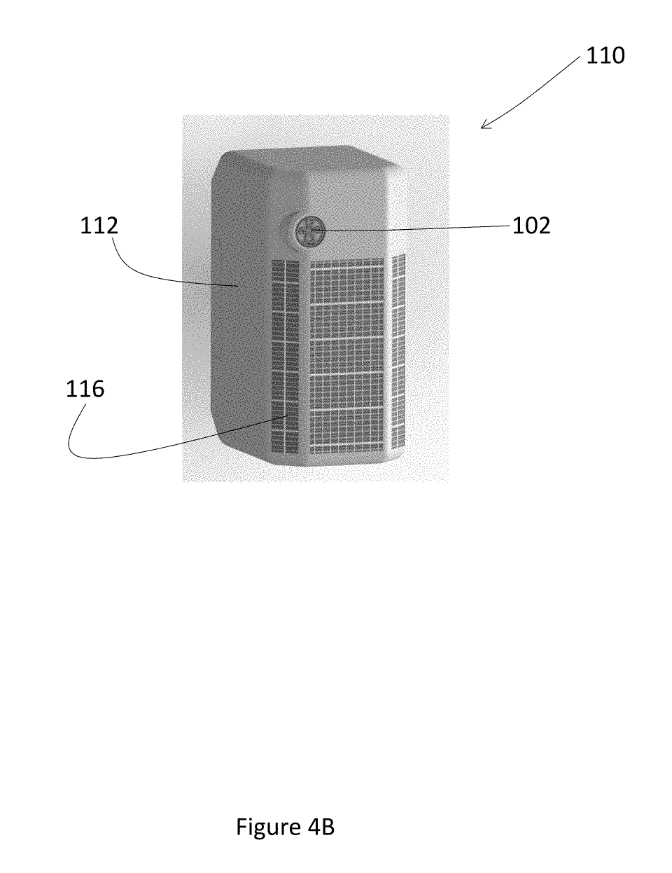

Turning to FIGS. 4A and 4B depicted therein is a stand-alone embodiment 110 of the transmission point 30.

The stand-alone embodiment comprises a main module body 112. In one embodiment, the module body 112 includes one exterior wall with apertures to allow for installation of the module body 112 on a horizontal or vertical wall 114. The main module body also includes one or more sensors, such as the motion or light detector 102.

The stand-alone embodiment 110 includes an array of solar panels 116 which provide it with a main source of power. The stand-alone embodiment 110 includes power saving features to allow it to be powered exclusively by the solar panels 116. In one embodiment, the main body 112 also includes a charging port (not shown) to speed up initial or subsequent charging of the stand-alone embodiment 110.

Each of the transmission point 30 embodiment 80, 92, 110 share common features within the associated main module. Each transmission point 30 receives signals from beacons 40, such as when a beacon detects movement in three dimensions from its accelerometer. The transmission point 30 forwards the received signals to the server, which transforms the raw data into an end-user presentation.

While the embodiments shown above are depicted as stand-alone modules, the transmission point 30 may be implemented using a software solution on a general purpose computer or handheld device. The principal requirement is that the transmission 30 hardware host include wireless communication means to communicate with the beacons 40 (such as Bluetooth) as well as an external network connection (such as Wifi) to the server.

In one embodiment, a transmission point 30 is implemented on a multi-purpose computing device, such as a cell phone, tablet, or another computing device. The transmission point 30 allows the end users to create a community, allows the sending of messages (such as advertisements) in any format, and to organize contests. The transmission point 30 coverage zone is used to deliver coupons and rebates, including ones that include a unique identifier and target a particular recipient, in one embodiment.

### Social Media Interaction

One of the options within the end user application 50 is to share information received from the server 20 to the user's contacts. In one embodiment, the end user application 50 integrates with the contact address book. In another embodiment, the end user application 50 integrates with the user's social media accounts, such as Facebook. As such, the contacts of the end user may cooperate in taking care of the end user's property and assist in the recovery of stolen, lost, or unreachable assets. In one example, the end user's social media contacts are alerted to a property event such as a tracked bicycle having been stolen. The contacts may assist in keeping track of property during periods of absence.

A connection to each social media service is made using the social media's publicly-available API, in one embodiment. The social media API is used to immediately notify the users and the social media contacts of the system of any alarms created by the sensor or beacon.

A benefit of the system is that it creates a register of the history of physical items, as well as providing a means to see their current status. The application 50 allows the end user to specify expected events (which are logged) and unexpected events—which result in an alert. The application 50 installed on a standard device turns it into a remote beacon sensor without requiring the standard device itself to act as a physical interrogator of the item beacons 40.

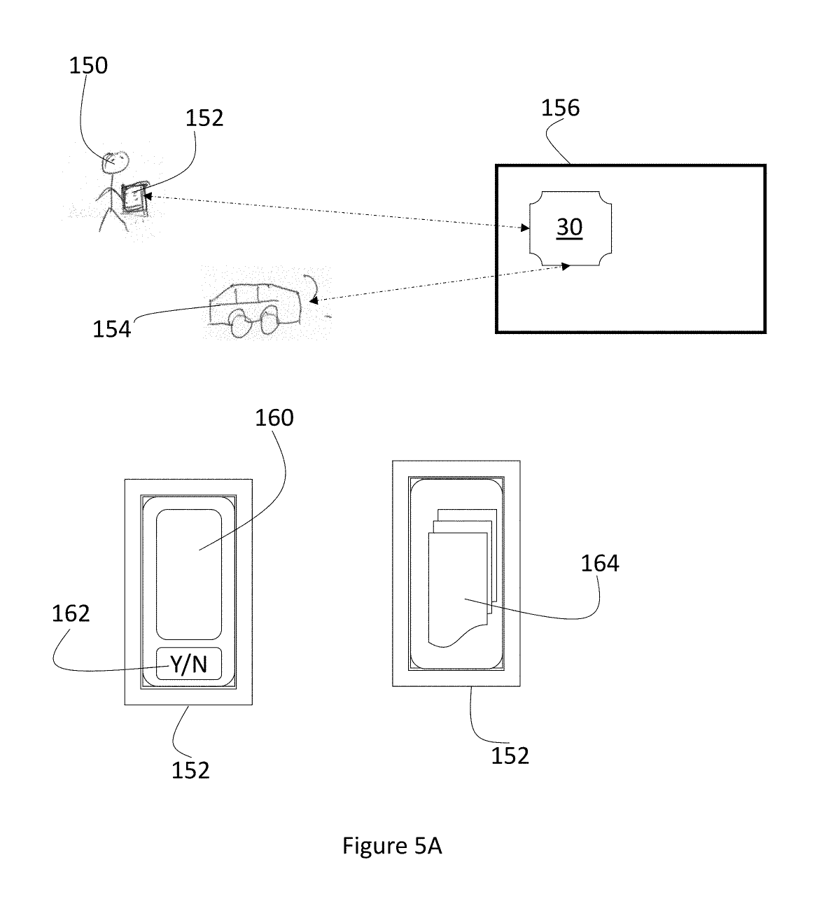

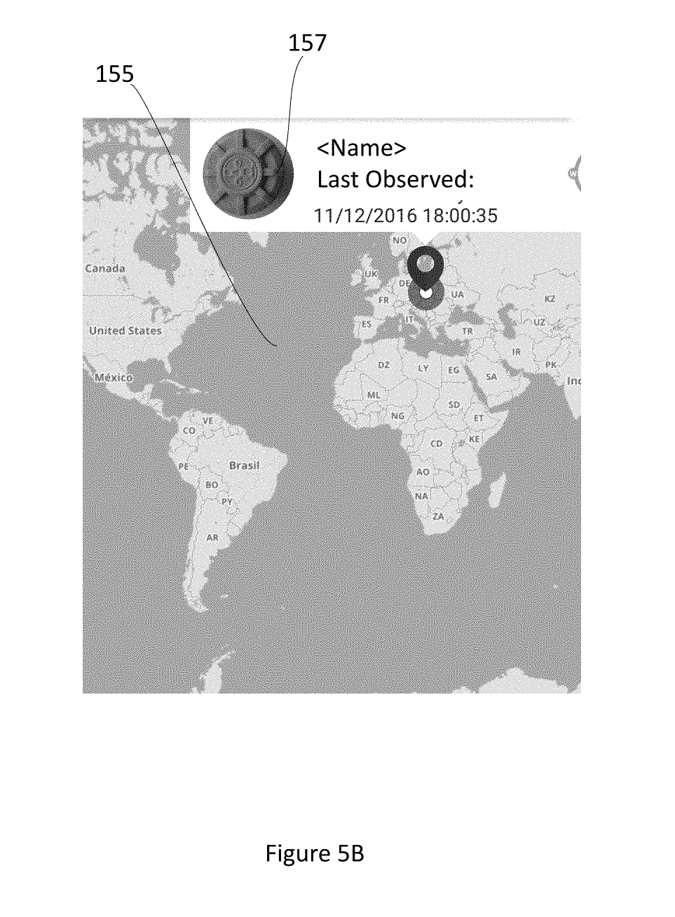

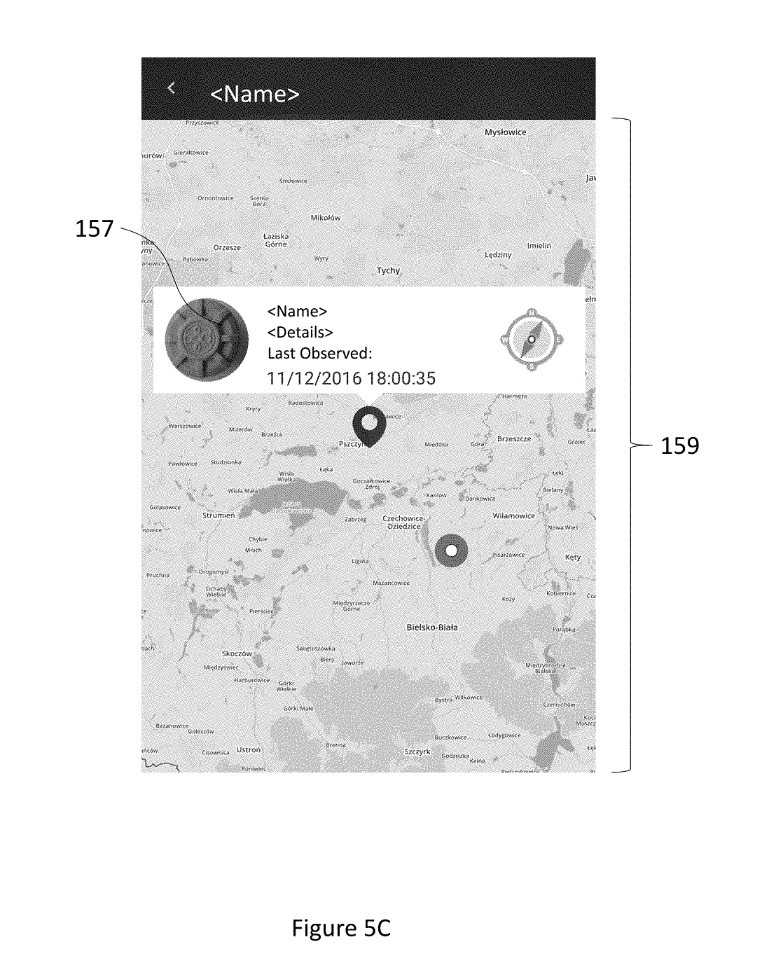

In one embodiment the application 50 allows for the display of locations of beacons 40 on a map showing the status of each beacon 40. A screen shot of a map 155 of beacons is shown in FIG. 5B showing a particular beacon 157, pursuant to one embodiment of the system. A detailed view 159 of the status of a beacon is shown in FIG. 5C.

### Example Information Exchange Method

Turning to FIG. 5, depicted there is a method for use of the system 10 to exchange information. In the example depicted in FIG. 5, an end user 150 has arrived at a physical store location 156. The user 150 has driven a vehicle 154 to the physical store location 156.

The physical store location 156 is equipped with a transmission point 30. The user 150 has a computing device 152 such as a cell phone with the end user application 50. The application 50 associates with the server (not shown) and is aware of the presence of the transmission point 30. The vehicle 154 includes a beacon 40, and so the vehicle associates with the transmission point 30 while parked in proximity to the store 156.

The computing device 152 displays to the end user 150 a first interaction 160. In one embodiment, this first interaction comprises a welcome message. In another embodiment, the first interaction includes information pertinent to the store 156 such as sales information. In yet a further embodiment, the first interaction 160 includes a confirmation message 162. The end user 150 must select the appropriate acknowledgment in the confirmation message to indicate acceptance of the store 156 first interaction 160. Upon accepting the first interaction 160, the end user device 152 displays a second message 164.

As such, the system 10 allows an end user 150 to receive context and location-specific messages without including location detection means in the end user's computing device 152.

Further, the system 10 is aware of the location of the end user's vehicle 154 and so can track the amount of time the end user sent in the store 156 as well as the amount of time which passed between checkout and departure. As such, the system may be used to detect misuses of the store's parking lot by non-customers or persons who have left the premises.

The application 50 receives from the system 10 advertising messages 164. In one embodiment, the advertising messages 164 are received in exchange for the user connecting to the Internet through the store 156 transmission point 30. The application 50 therefore acts as a means to display messages and offers for the store 156 without the store having to build its own location-aware application and without having the end-user download the application on the user's phone.

The application 50 allows for tracking of the user's needs, preferences, and behavior while visiting the store 156, especially if the store 156 incorporates beacons 40 into the merchandise. In one embodiment, the application 50 tracks the user's path taken within the store and the amount of time spent in the store 156. In one embodiment, the application 50 also monitors the user's social media interaction while at the store 156.

### Property Tracking Example

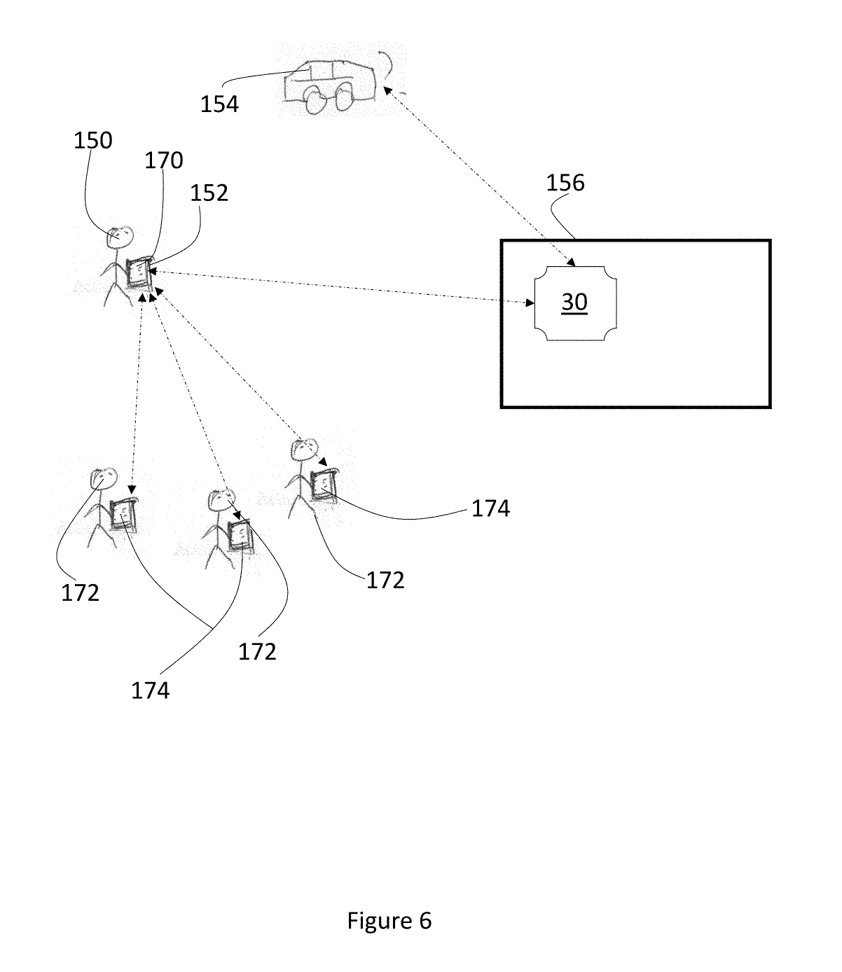

As shown in FIG. 6, the system 10 may be used to raise alarms regarding personal property. As shown in FIG. 6, an end user 150 has arrived at the store 156. Initially, the user's vehicle 154 is securely parked and the vehicle's beacon 40 registers with the store's transmission point 30. While the user 150 is away from the vehicle 154, the vehicle 154 begins moving, indicating theft. The user receives a primary alarm 170 from the server (not shown). The user's active associates 172 also receive a secondary alarm 174. As such, the active associates 172 may provide assistance to the user 150, or simply indicate their response to the apparent theft of the vehicle 154.

In one embodiment, the system 10 detects the attempted theft of tagged property using the following steps. First, an assailant attempts to steal property which includes a beacon 40. Second, a sensor within said beacon 40 detects motion and transmits the detection to the base station and server. The server pushes a notification to the end user's 150 cell phone or other mobile computing device indicating an anomalous situation. In this embodiment, an alarm is raised automatically, or in another embodiment, the user 150 is presented with a screen to determine whether an alarm should be raised. In another embodiment, the user 150 is provided a period of time to decline the alarm, which by default is raised. If the user 150 decides to raise the alarm, a local alarm is raised, include the secondary alarm 174 using at least one social network API. The user's associates 172 therefore can assist in locating the property, or can offer their assistance to the end user. In one embodiment, the store 156 is added as a secondary alarm 174 recipient while the end user 150 is located on the store's premises. As such, store 156 security will be instantly notified of the secondary alarm 174.

The selection of associates 172 occurs both within the ambit of the social network, as well as within the system 10.

### Further use Examples

In use, turning on the system 10 as well as activation of beacons 40 with the system 10 through the transmission points 30 enables mapping and functions related to the physical location of the tracked beacon 40.

Upon first initialization of the system, the base station or transmission point 30 connects with beacons 40 in range. In one embodiment, beacons 40 regularly check for wireless broadcast signals to determine if a transmission point 30 is not within range. Upon initializing, the transmission point 30 enters into a steady-state wherein the transmission point 30 requests the status of each associated beacon 40. Each beacon 40 responds with a status message, in one embodiment, each beacon 40 further includes a memory buffer such that previous status messages, which were not transmitted, are sent to the transmission point 30 upon establishment of a steady-state connection with same.

In one embodiment, the system 10 forms a network of devices, including one or more servers 20, transmission points 30, beacons 40, and user applications 50. The network components do not need to communicate directly with one another and can use a multi-user network such as the Internet. As part of the establishment of the network, items tracked with beacons 40 are ‘docked’ into the network by being associated with one or more transmission points 30. As part of docking, location and other sensor readings from the beacons 40 are established. Even slight movement following this step will be logged and can result in an audible or non-audible alarm. A part of the alarm procedure is notification of security or police, in one embodiment, as well as notification of user contacts (as described above). A user accessing the application 50 is notified of the location of the alarm. In one embodiment, the application 50 also suggests the person who should be provided the secondary alarm 174, either directly or through social media.

In one embodiment, the beacons 40 operate through direct communication with the user computing device 58, bypassing the transmission point 30. In this embodiment, the beacon 40 transmits sensor readings to the application 50, bypassing the transmission point 30. Also, in one embodiment, at least one beacon 40 includes active sensors that attempt to identify any equipment being carried by an apparent thief, such as by attempting to intercept cell phone tower pings, or other identifiable information, to the extent doing so is permitted by regulations and law.

In another embodiment, a multi-purpose computing device 58 includes software programs which allow the device 58 to act as a transmission point 30. In this embodiment, an end user's cellular phone, laptop, or stationary computer can act as a transmission point 30, so long as the end user device includes at least one wireless network interface.

The system 10 may connect with an unlimited number of beacons 40 and other sensors. By using multiple transmission points 30, the system 10 can cover an unlimited physical space.

### Business Process Integration

In one embodiment, the application 50 is used to ensure that beacons 40 show compliance with business rules. For example, following rule definition, the application 50 can confirm that workers are following safety or hygiene rules. For example, where the beacons 40 are attached to safety equipment and employees, the system 10 can confirm that every employee entering a hazardous area has taken the appropriate safety equipment.

The beacons 40 are attached to moveable industrial equipment, in one embodiment. In this embodiment, the beacons 40 track work related to pipelines, ensuring that every length of pipe has been inspected. The beacons 40 are used to track equipment within a mine, in another example. The application 50 provides information for a particular industrial environment, in one embodiment, as well as safety information or safety alerts. In one embodiment, the application 50 notifies an end user if the end user has entered a hazardous area (such as proximity to a ledge or area of digging in a mine) and takes steps to remove a user from a hazardous area if the user lacks the necessary protective equipment.

In this manner, the system 10 is used to automate processes which were previously exclusively manual and also allows for additional information to be learned about a process, such as the amount of time workers require to complete a task. For industrial areas that include difficult or hazardous environments, the system 10 uses expensive hardened beacons 40 and ruggedized transmission points 30.

One embodiment includes beacons 40 and transmission points 30 optimized for use within a mine. Such transmission points 30 include additional battery backup, and directional antennas, which optimize the coverage of the system to only the space where beacons 40 can reasonably be expected to move.

### Complementary Technologies

The system 10 can be used with modules and system components from a number of complementary technologies. These complementary technologies may be selected to fulfill specific end-user requirements. For example, the system 10 incorporates Smart Home technologies, in one embodiment. The system 10 is incorporated with vehicle anti-theft and insurance systems, in another embodiment. The added value for the end user comprises both real-time monitoring of property, as well as participating in a virtual security social network, ensuring both detecting of theft as well as detecting and reacting to anomalies in the surrounding environment.

As the system relies on Bluetooth to communicate with the end-user sensors, the system 10 may use any number of existing Bluetooth devices such as microphones, speakers, cameras, and others to respond to changes in the environment. By using one or more transmission points 30, the system 10 allows for virtually unlimited gathering of data from a wide variety of sensors without requiring every device to have a connection to the server.

The system 10 provides a new way to detect changes to property as well as geo-location of assets along with forming a registry of active and past events which can be analyzed by the end user.

The sharing of beacon 40 status provides additional functionality and allows for the creation of safe zones or zones where the property is being monitored closely by many concurrent users. Remote monitoring is possible even though each beacon has a range of only about 70 meters. Each transmission point 30 has a range of approximately 450 meters.

The resulting network of beacons 40 and transmission points 30 is decentralized such that the loss of any one beacon 40 or even transmission point 30 is not critical to the operation of the system 10.

### Messenger Embodiment

In one embodiment, the system 10 also includes a means to exchange location-aware messages. In the messenger mode, the system 10 relies on the network formed by the beacons 40, and transmission points 30 using Bluetooth communications. The results are shared with the application 50. Users of the application 50 may exchange text, audio, and video messages, while they remain in range of a transmission point 30, even if the two users are not communicating with the same transmission point 30. In one embodiment, the two devices are paired prior to exchanging information.

For example, in one embodiment, a package delivery courier wishes to deliver a package. However, the recipient is not available. While the courier is standing in front of vacant premises, the courier can send a secure message to the end user using the application 50. The recipient can be certain that the message originates from a specific physical location, as the courier is in the range of the transmission point 30 located on the premises. The recipient can use the transmission point 30 to allow the courier limited access to the premises or can send one or more messages to the courier, including signing for the package if necessary.

Overall, the system accommodates tracking of items for purposes of preventing item loss as well as for other value-added reasons. The system provides a method of transmitting location-aware information using low-cost physical sensors and multi-use computing devices such as cellular phones, without using the phone's location systems.

The application can be downloaded and used by end-users for free. In one embodiment, the paid functions include sending of targeted location-aware advertisements. Further paid functions include the creation of interactive advertising messages, and others.

In one embodiment, the users 50 of the system 10 are required to agree to specific terms of use, and are prohibited from sending advertising messages to other users without the recipient's permission. In this embodiment, the system 10 is closed to unauthorized users and users who may try to exploit the system for sending of spam.

### Example Implementation

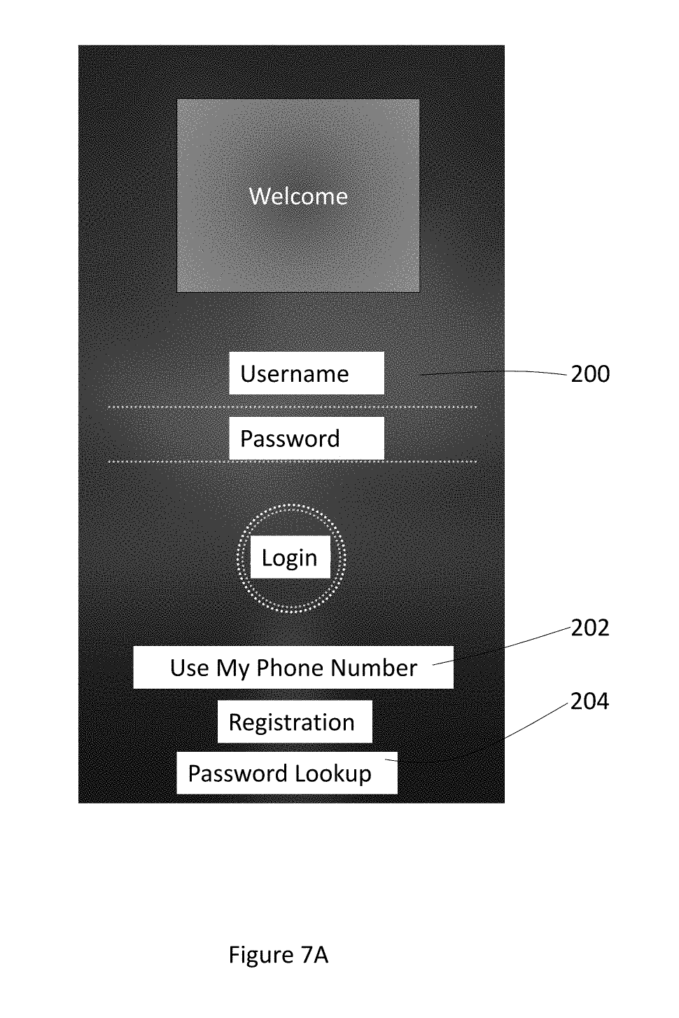

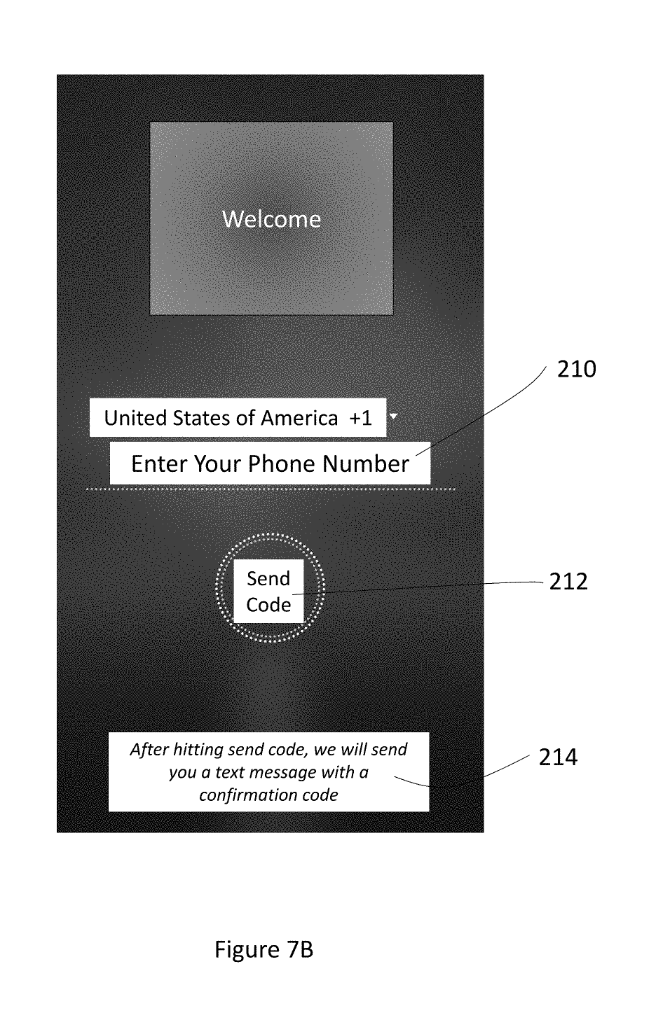

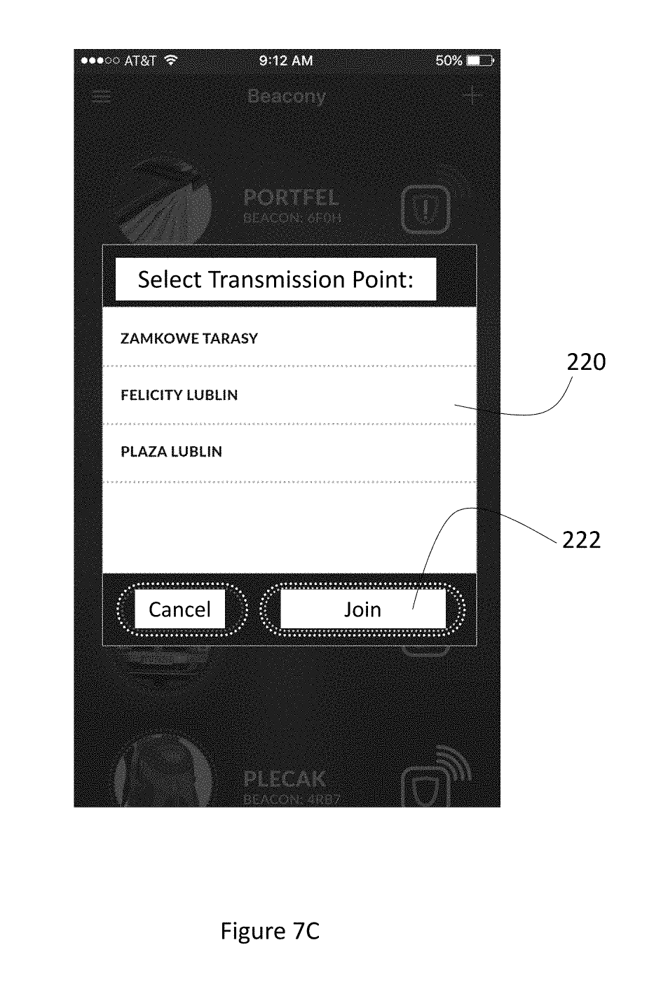

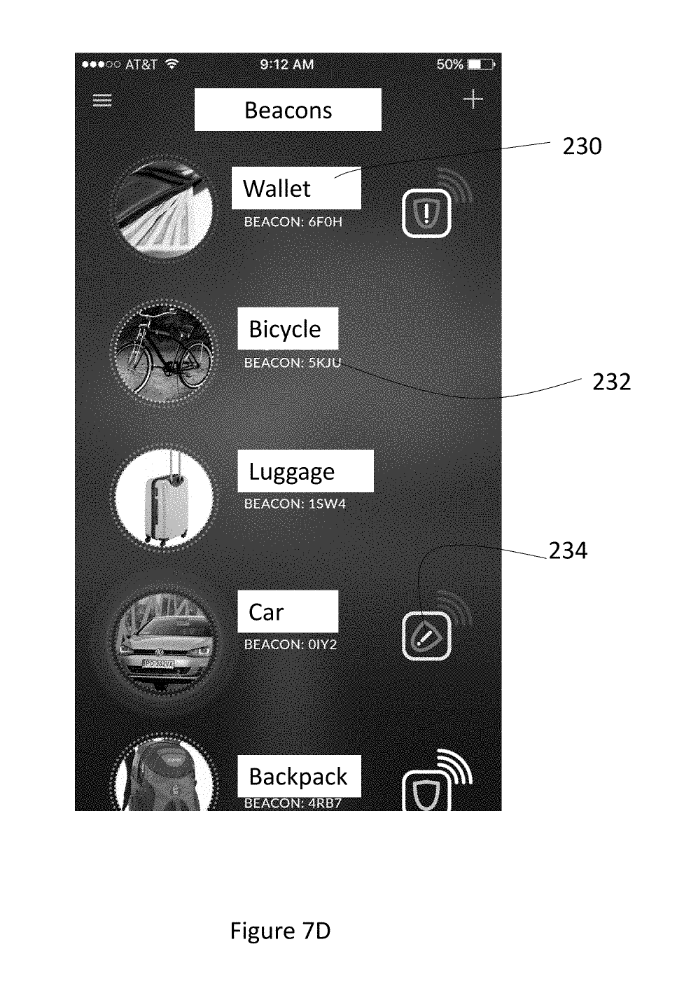

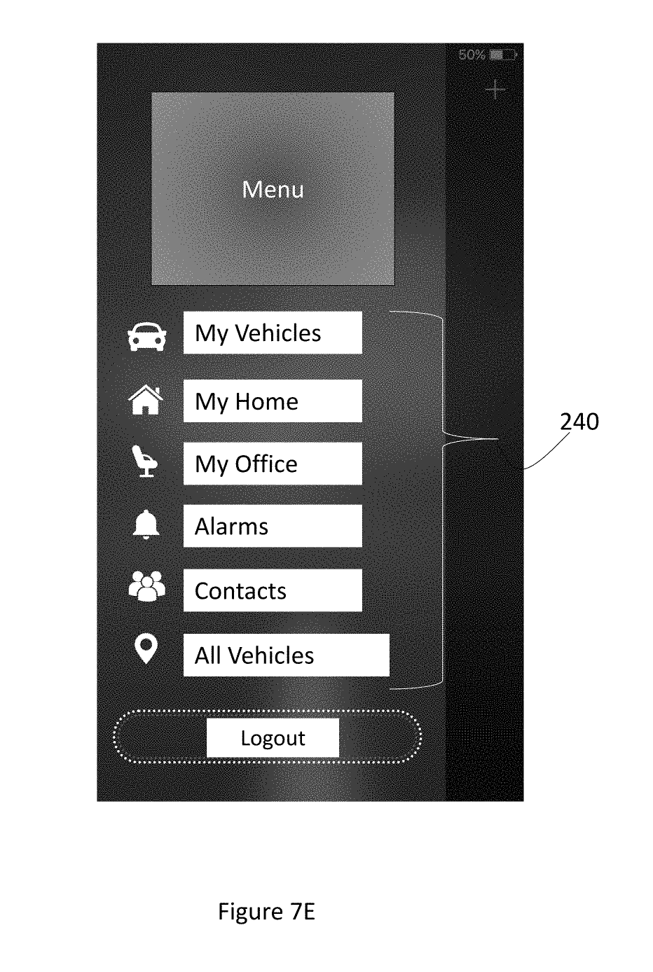

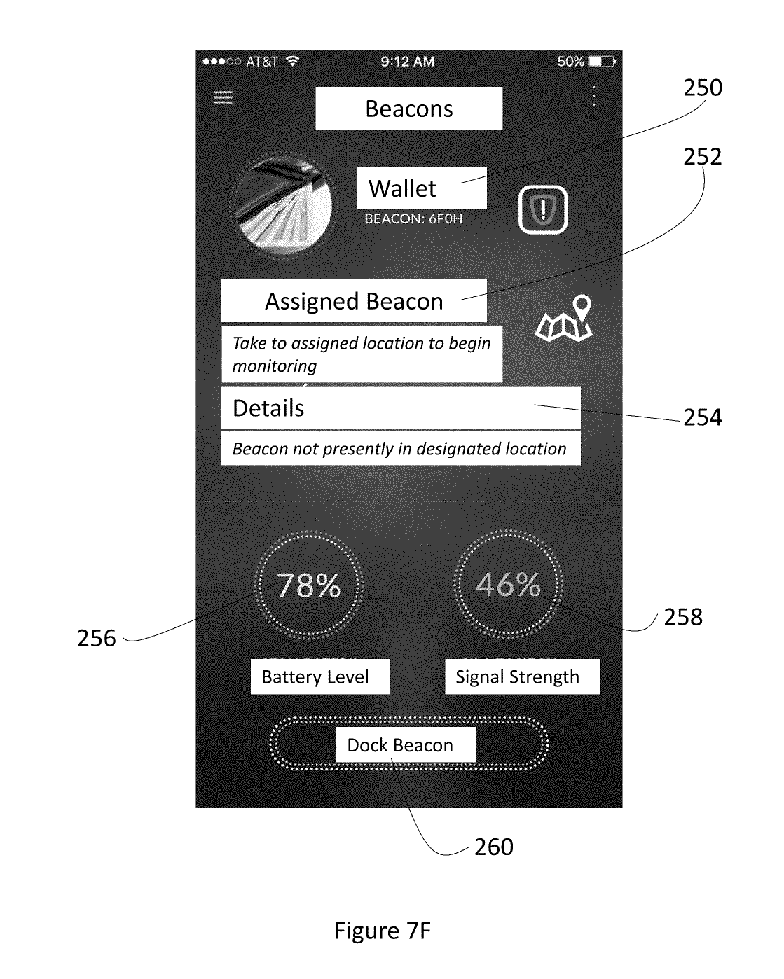

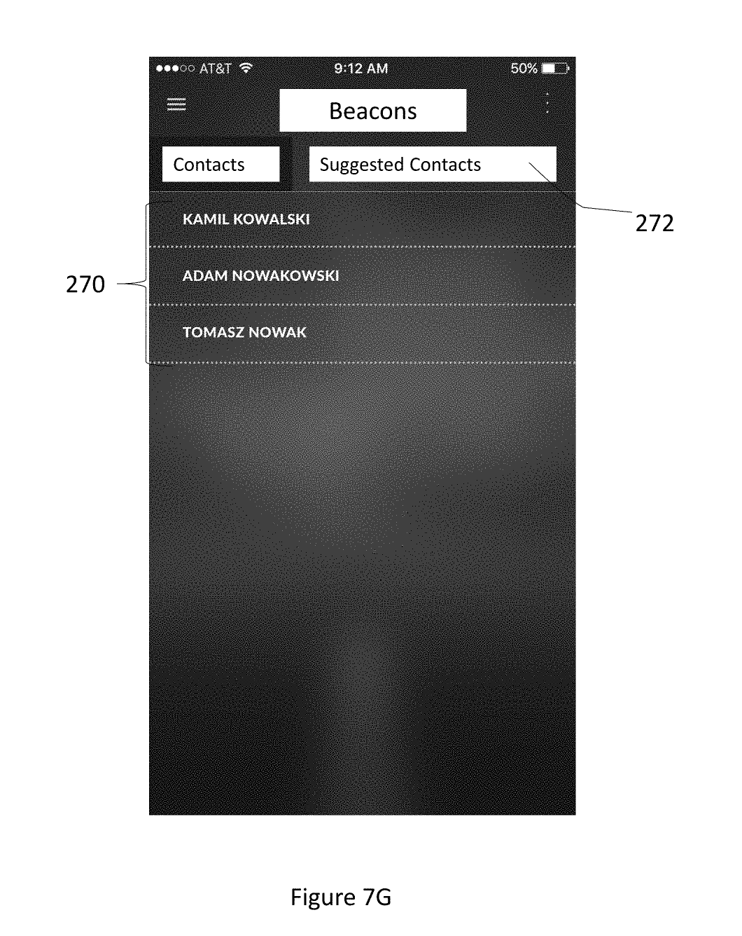

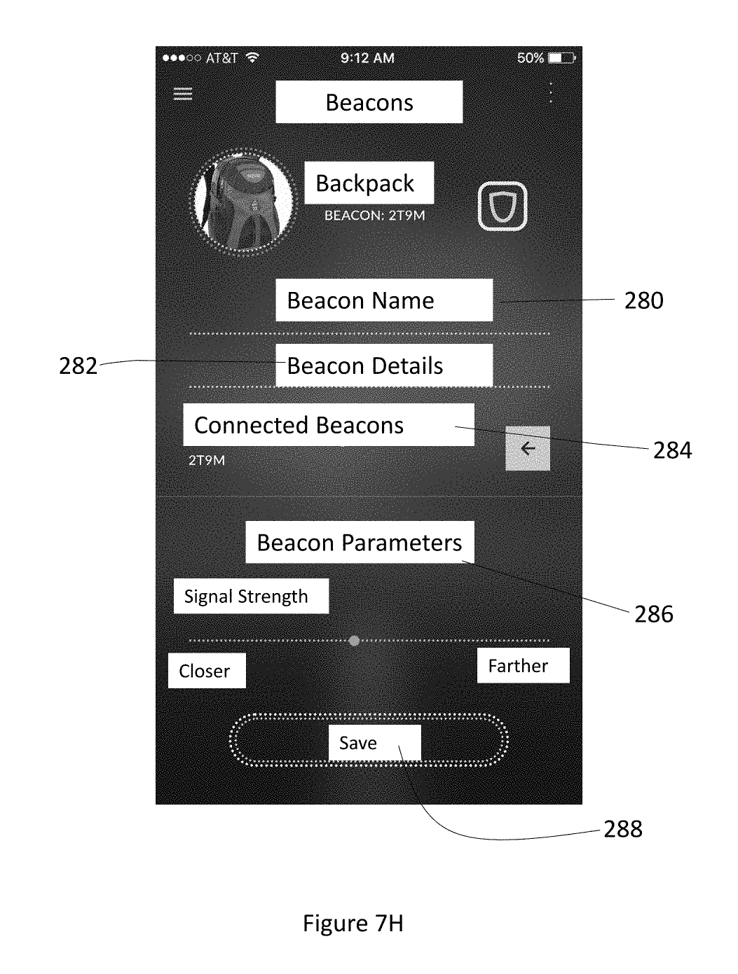

FIGS. 7A-H depict a series of screens of one embodiment of the invention.

FIG. 7A shows the login screen of one embodiment. The login screen comprises areas 200 for current users to login using a username and password. In one embodiment, the login credentials are securely stored on the host device, obviating the need to login using a username and password. The end user may also initiate the system using a phone number 202. Further, from the initial screen, the end user may also register for the system by invoking the registration function 204.

As shown in FIG. 7B, the system requests that any phone number be confirmed. The end user enters their phone number in the field 210. The system supports many countries and methods of sending confirmation codes, such as text messages, multimedia messages, recordings to voicemail, and others. Instructions on steps to confirm the phone number are provided on the screen—in most instances the end user will need to confirm the code sent by the system.

Per FIG. 7C, upon logging in (after optionally setting up an account), the user is presented with a list 220 of transmission points. The end user may join any one of the points from the list 220 by selecting the point and pressing join 222.

The user can also manipulate beacons, as shown in FIG. 7D. For each beacon 230, its identifier 232 and status 234 are shown.

To help the end user organize all assets within the system, categories 240 can be established, as shown in FIG. 7E. In the depicted embodiment, the categories include Vehicles, Household Items, Office Equipment, and others.

Beacon details are shown in FIG. 7F. The beacon name 250, its status 252 and details 254 are shown. Also transmitted are the beacon battery level 256 and signal strength 258. As shown in FIG. 7F, the tracking of activity of a beacon begins when it is taken to its intended destination. In order to set a current location as the intended destination, the end user may dock the beacon by invoking the appropriate feature 260.

The contacts or social media features are shown in FIG. 7G. In the depicted embodiment, for a given beacon, the user sets a number of contacts in a contacts list 270. The system may also suggest contacts 272, such as for example suggesting security or maintenance staff for office equipment.

The established of a newly added beacon is depicted in FIG. 7H. The user may enter the beacon name 280 and details 282. The user may review other connected beacons 284. The user may also specify a number of parameters for the beacon, such as the signal strength 286 depicted in the Figure. Finally, the user may save the changes 288.

### Embodiments Moving in Three-Dimensional Space

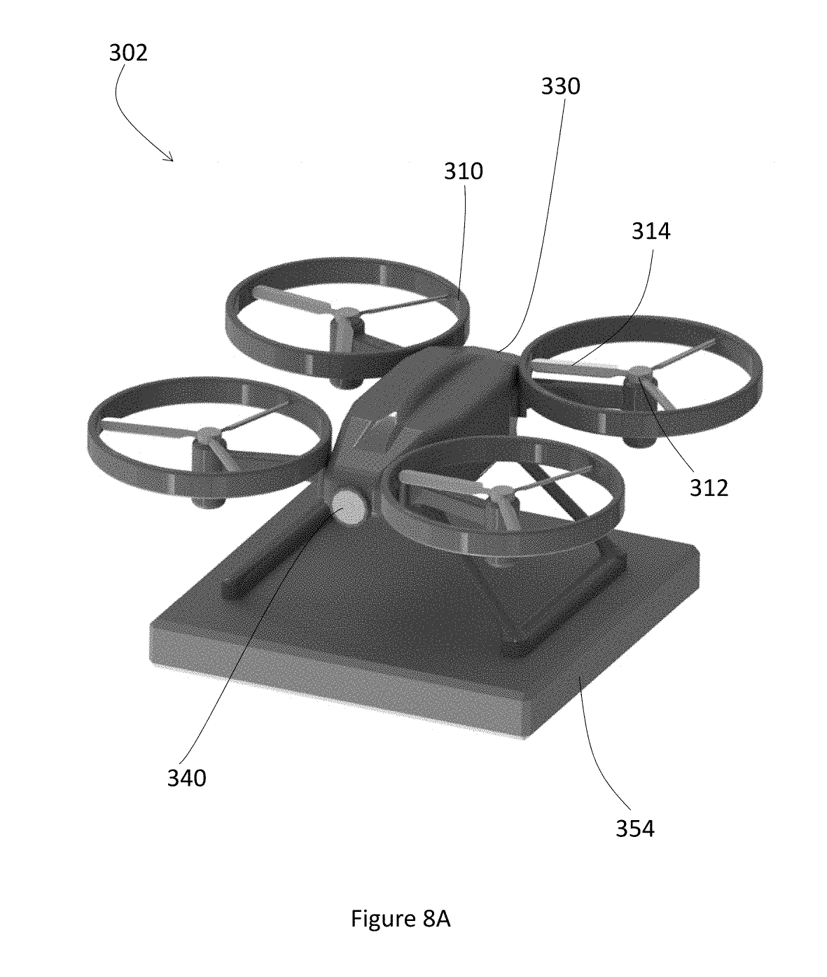

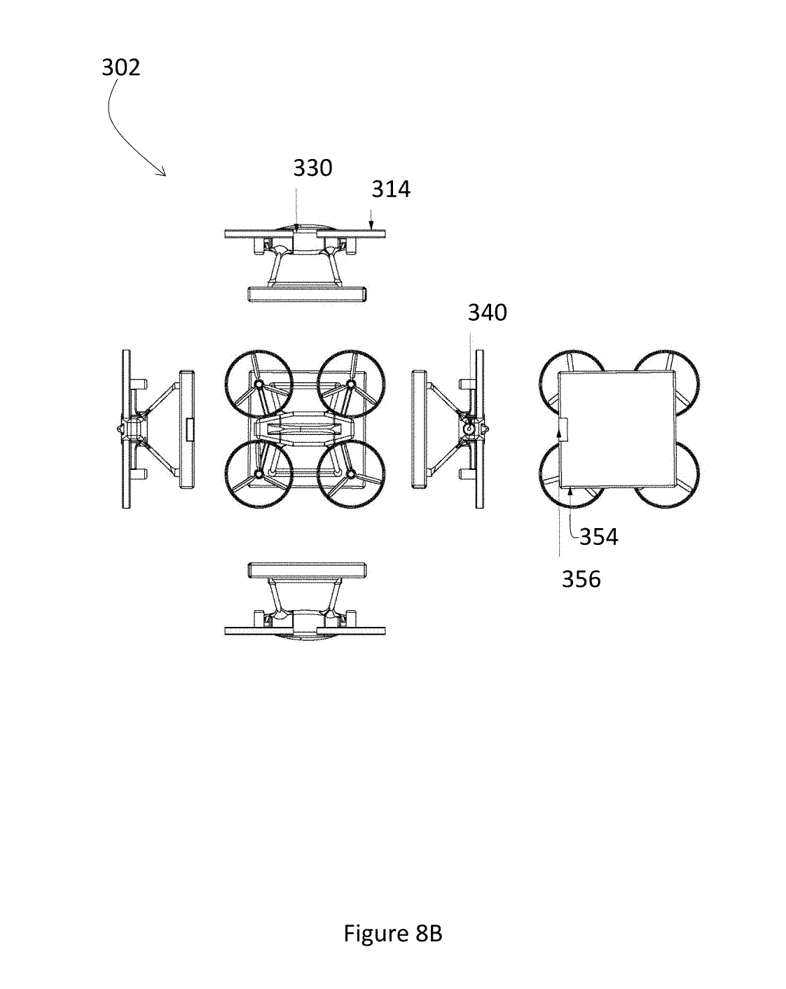

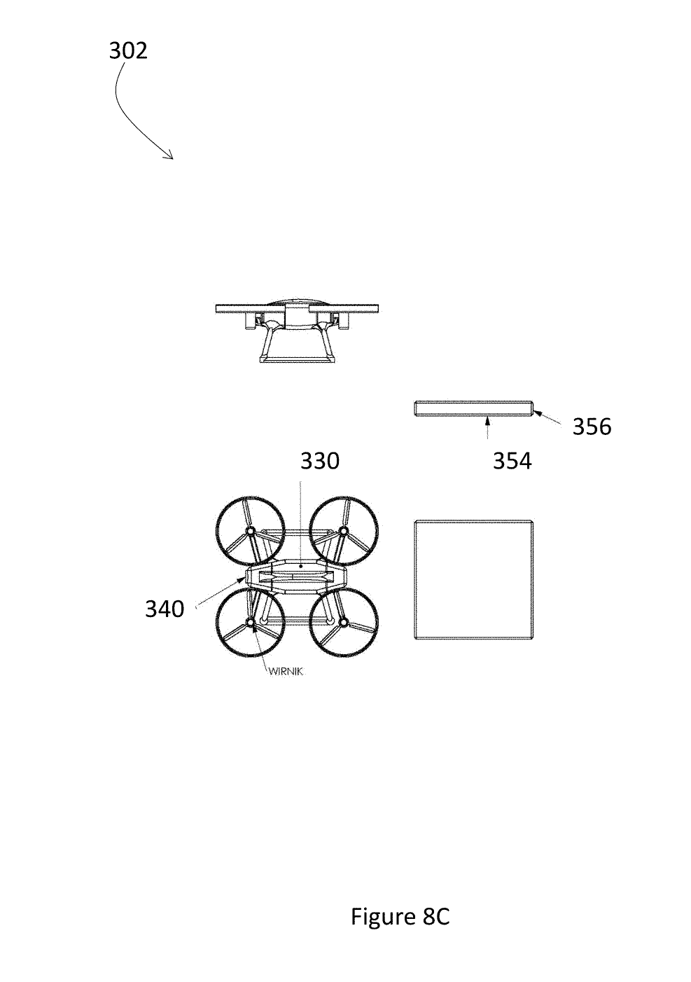

Additional embodiments are depicted in FIGS. 8A-C. Depicted therein are embodiments of components of the system capable of moving in three-dimensional space. One of the problems encountered by the system is the reach of the signal of each base station. Further, certain components of the system need to remain in a stationary position, and so the components are mounted on objects capable of movement in three-dimensional space.

As shown in FIG. 8A, a mobile device 302 comprises a mobile transmission point 330 and a mobile movement mechanism 310. In the embodiment shown in FIG. 8A, the mobile movement mechanism 310 comprises an array of rotors 312 and blades 314. In the depicted embodiment, the mobile device 302 is a small-scale drone aircraft. As depicted in subsequent figures, the mobile device 302 is capable of autonomous movement and is self-balancing. The mobile device 302 includes a number of enhancements in one embodiment, including onboard interference deterrent systems. The programming of the mobile device 302 allows for detailed itineraries of movement, with the opportunity to customize the duration and extent of each flight path.

The mobile device 302 includes a mobile transmission point 330. As the stationary transmission point 30, the mobile transmission point 330 includes several wireless transmission systems, in one embodiment, as well as other network connectivity. The mobile transmission point 330 is in wireless communication with any beacons in range, however, the beacons are informed that the strength of the signal with the mobile transmission point 330 will vary. Information from the mobile transmission point 330 is sent to the server communication system 54 akin to the stationary transmission point 30. The mobile device 302 is charged upon landing on the charging or docking station 354. In one embodiment, the mobile device 302 is charged using inductive charging. In another embodiment, the charging or docking station 354 includes exposed conductors with analogous exposed conductors on the mobile device 302 to facilitate electrical contact between the station 354 and device 302. In another embodiment, the device 302 is charged using an inductive or other form of wireless charging system employing a wireless charging pad.

The mobile device 302 further comprises a video camera 340 which captures video of the mobile device 302 environment. In one embodiment, the camera 340 locates and is focused on areas where beacons undergoing an abnormal state were last reported.

In one embodiment, the mobile device 302 is manually guided, in another embodiment, the mobile device 302 autonomously selects a traveling path once parameters of travel are set. In this autonomous embodiment, one of the parameters of travel is a static list of beacons to visit.

In another embodiment, the travel path by the mobile device 302 is dictated by beacons which have reported an anomalous sensor reading. In this way, the mobile device 302 will prioritize visiting beacons reporting potential dangers, or other problems. In one embodiment, the mobile device 302 updates its path autonomously on basis of a list of locations to visit, in another embodiment, the mobile device 302 proceeds directly to the area where a problem or danger is reported. In an embodiment where the mobile device 302 is guided manually, the operator of the device 302 is provided with a list display of trouble areas requiring further investigation.

In one embodiment, the mobile device 302 includes an array of directional microphones, and so the device is able to detect sound waves, as well as triangulate the origin of same. In this embodiment, the mobile device 302 will alter course to obtain sensor readings and to provide a video feed, in response to a sound. In one embodiment certain sounds are prioritized in setting a travel path, such as a person yelling, glass breaking, or an animal vocalizing. In one deployment, the mobile device 302 is used in an agricultural context, and the mobile device obtains readings of a perimeter fence, prioritizing verification of an area where fence continuity may be broken. In one embodiment, the mobile device also interacts with sensors carried by each animal, and will move to record readings or otherwise respond to areas where potential danger has developed.

In one embodiment, the traveling path is initially selected and also modified in response to online communications received by the mobile device 302. In one embodiment these online communications comprise instructions by end users or operators. In another embodiment, the online communications comprise instructions automatically generated by an application which detects potential trouble areas and analyzes detected movement in the environment.

Additional views of the mobile device 302 are shown in FIGS. 8A and 8B. As shown in FIG. 8B, the base station 354 includes a base station power supply 356.

### Mobile Device Environment Interaction

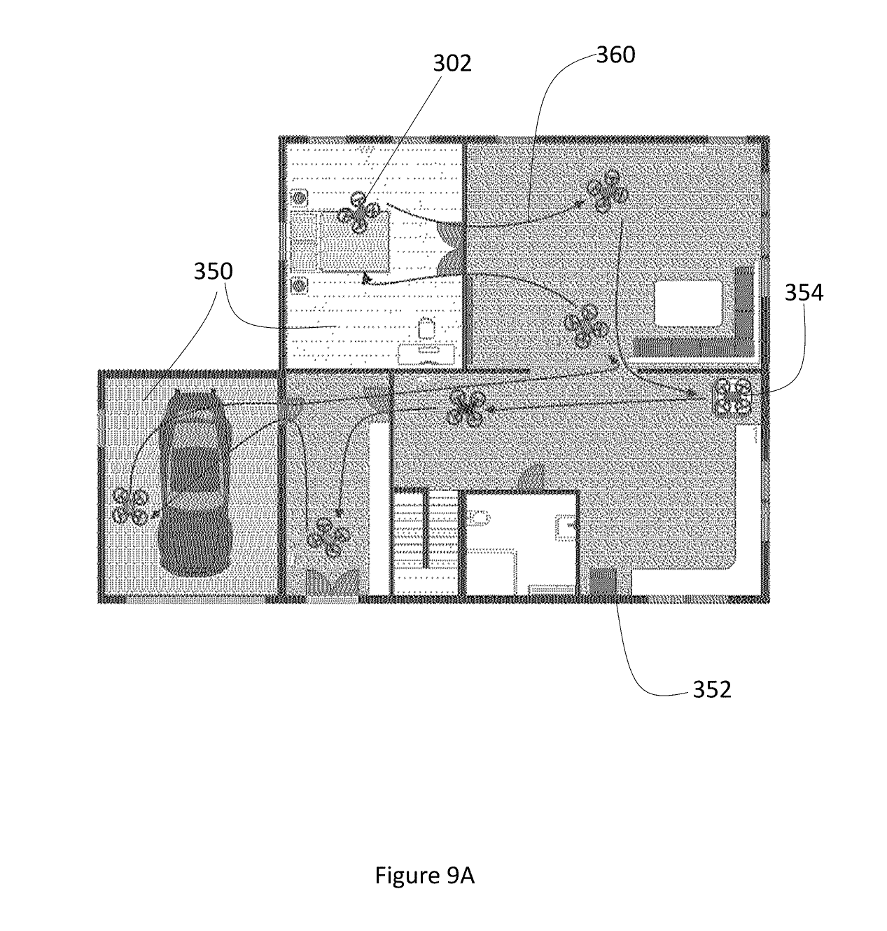

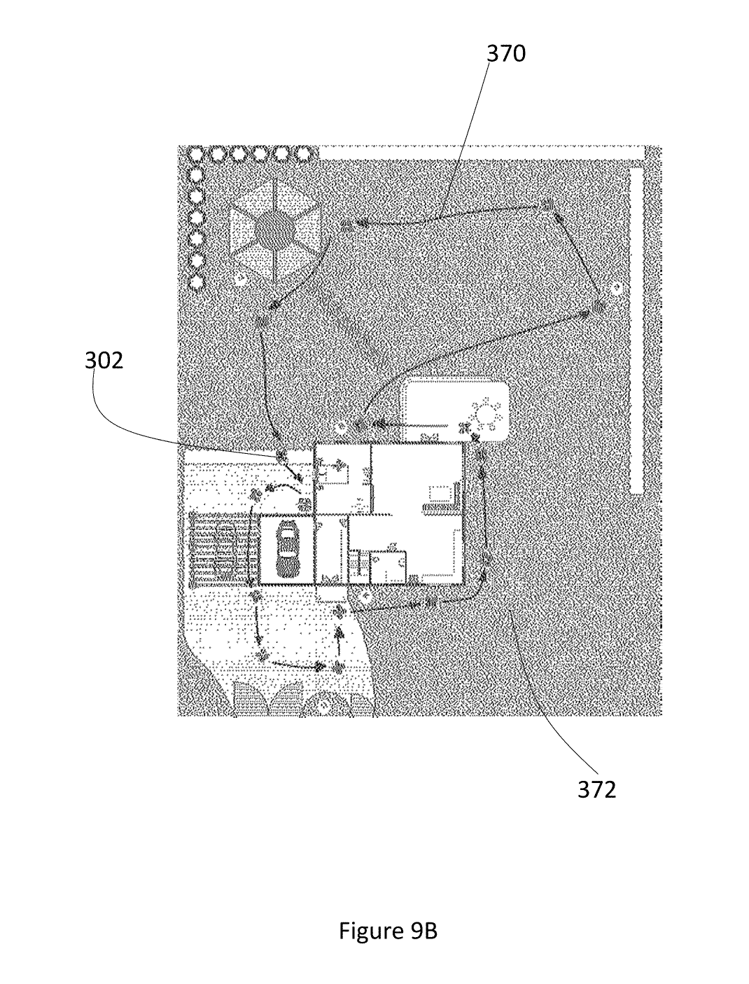

Turning to FIG. 9A, depicted therein is a mobile device 302 traveling through various rooms 350. The mobile device 302 follows a path 360 visiting the rooms 350 of the premises 352. As part of its path 360, the mobile device 302 includes a charging or docking station 354. During travel over the path 350, the mobile device 302 communicates with any beacons on the premises, as well as gathers video using the webcam shown in FIG. 8A.

While in FIG. 8A, the path 360 is limited to the premises 352, in the embodiment shown in FIG. 9B, the path 370 of the mobile device 302 extends to an exterior area 372 of the premises 352. Similarly, the path 370 extending to the exterior 372 comprises a scanning pattern of possible beacons in the area, as well as gathering of video information about the exterior area 372.

While as shown in FIG. 8A, the mobile device 302 includes a dedicated web camera 340, in other embodiments, the functionality of the mobile device 302 is added to a transmission point 30 which implemented on a multi-purpose computing device, such as a cell phone, tablet, or another computing device. The camera, position detector, accelerometer, and other sensors integrated into the multi-purpose computing device are used to create a mobile device 302. In one embodiment, the multi-purpose device is coupled with a movement mechanism 310. In another embodiment, the multi-purpose device is not capable of autonomous movement, but rather is carried along a path (such as path 360 in FIG. 9A) by an external force.

In one embodiment, a cell phone being carried by a security guard acts as a mobile device 302, querying beacons found on the premises, while the security guard carries the cell phone to various waypoints within the premises.

### Additional Embodiment

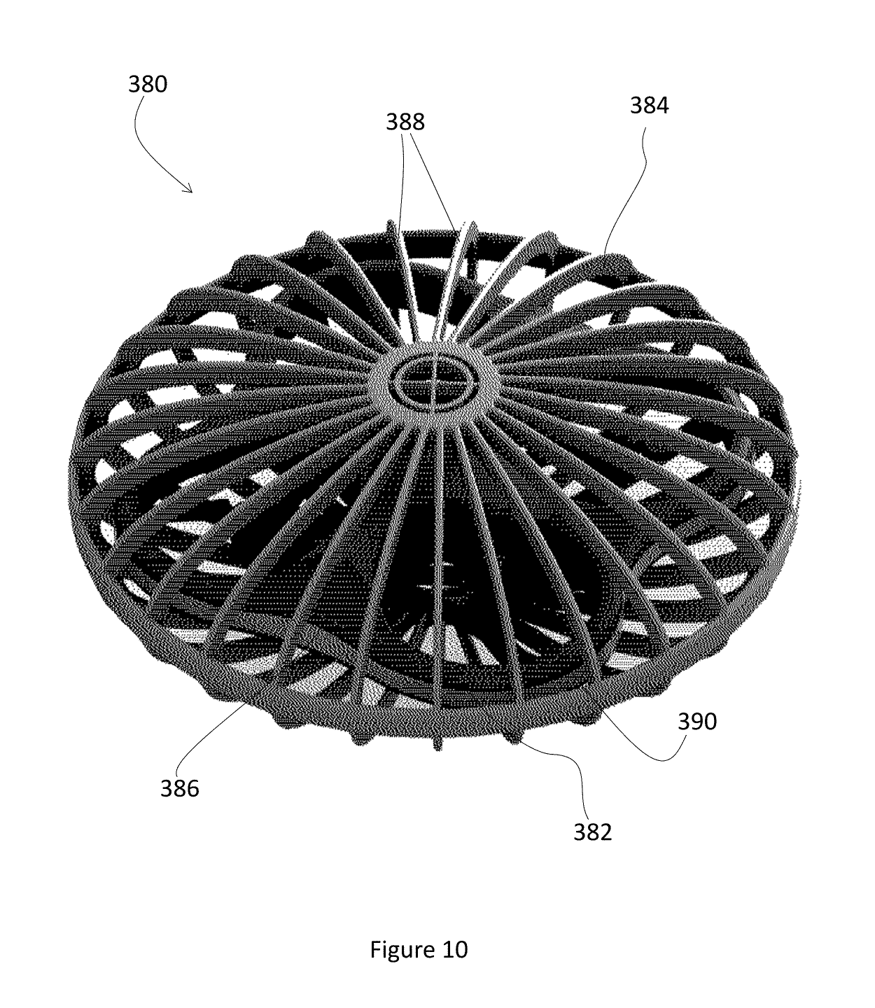

An additional embodiment 380 of the mobile access point is depicted in FIG. 10.

The alternative embodiment 382 comprises an outer frame 384 designed to improve the embodiment's security and durability, as well as to provide additional surface area to engage the unit during launching (described in conjunction with later figures). As shown in FIG. 10, the outer frame 384 comprises a tight grid array of reinforcing ribs 388. The ribs form both a top and bottom surface of the outer frame 384.

Contained by the outer frame 384 is an inner drone device 382 including an array of rotors 390 providing lift and allowing for maneuverability of the embodiment 382. The inner drone device 384 includes defined flat areas 386 on which sensors, wireless antennas, and other equipment is mounted.

A benefit of the additional embodiment 380 is that it depicts a frame 384 which may be added to an existing drone to improve its compatibility with launching systems and to improve the security of the done.

### Drone Launching Systems

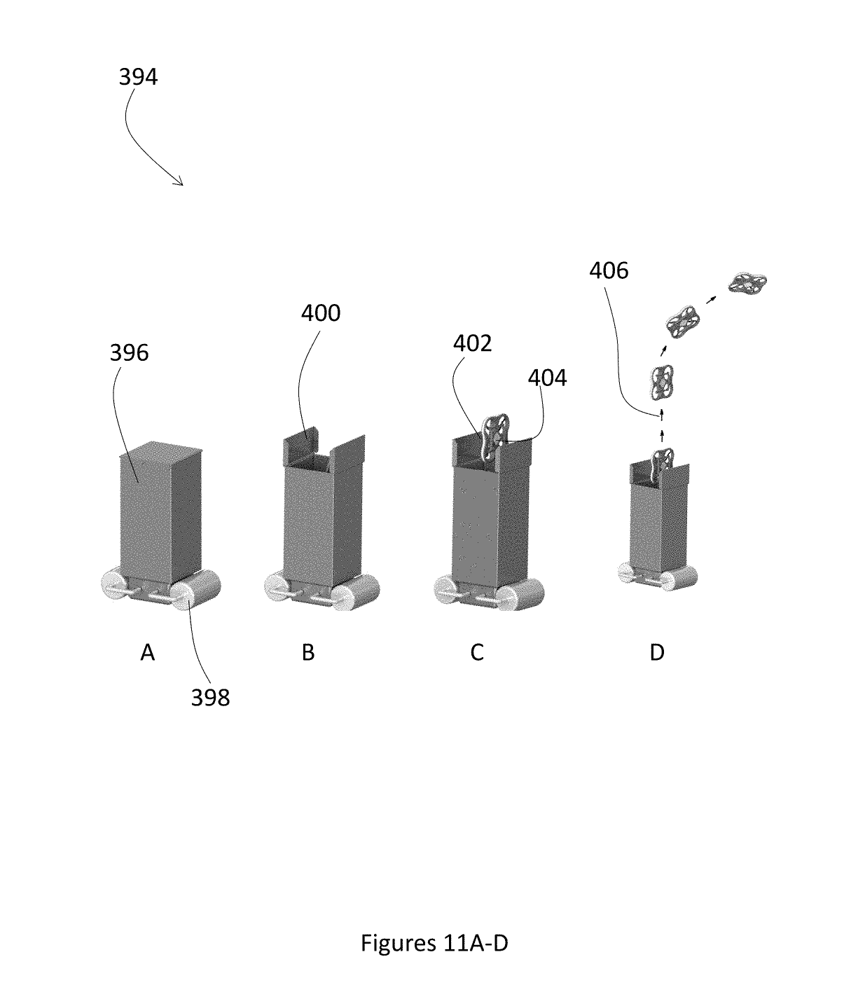

Turning now to FIGS. 11A-D, depicted therein is a system 394 for deployment of drones. The system includes a container for drones 396 which acts as both a storage for the individual drones, but also a launching system.

The process of launching the drone from the container 396 is shown in order of FIGS. 11 A to D.

First as shown in FIG. 11A, the container 396 moves into position by actuating its wheels 398. In one embodiment, the container 396 moves autonomously once a desired location is indicated. In another embodiment, the container 396 is moved by an operator. While roller-type wheels are depicted in FIG. 11A, any number of wheel configurations are possible. Next, as shown in FIG. 11B, the top 400 of the container 396 is opened. An individual drone 404 is propelled from the interior 402 of the container 396 using the initial starting mechanism discussed below.

As shown in FIG. 11D, upon emerging from the open top 400 of the container 396, each drone begins its own autonomous movement in the general direction indicated by the arrow 406.

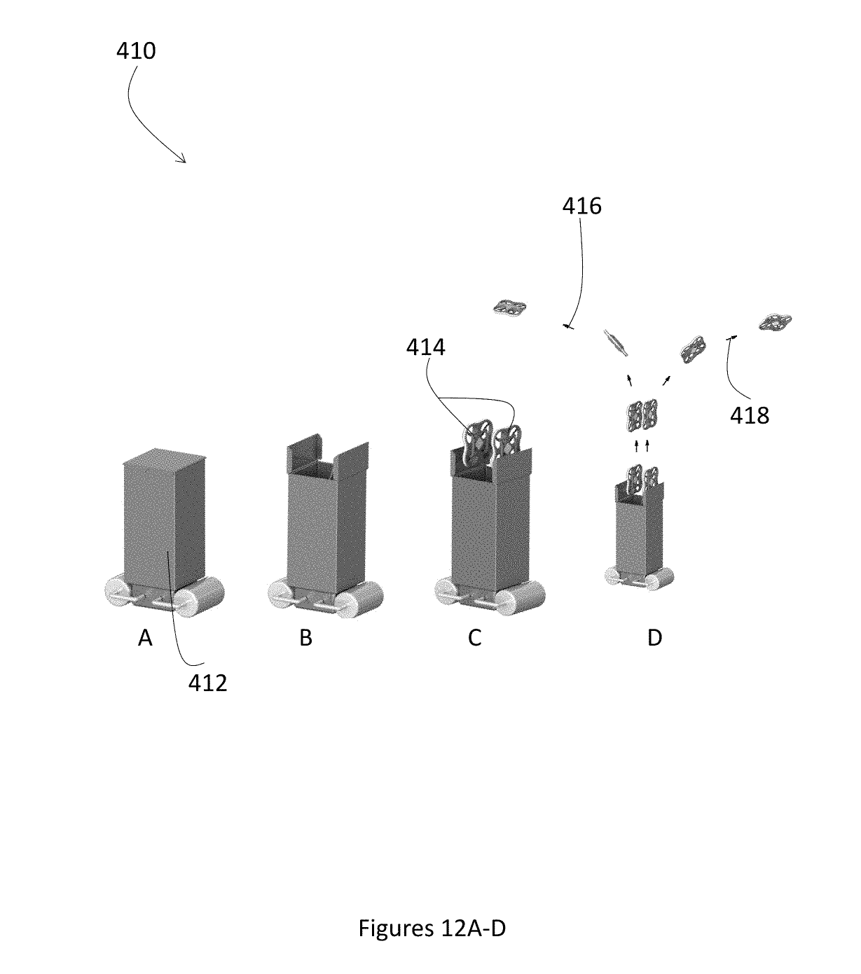

An alternative embodiment 410 of the launch system is depicted in FIGS. 12A-D. In this embodiment, each container 412 launches multiple drones 414. As shown in FIG. 12D, upon launching the drones begin traveling in opposing directions 416, 418. While two drones are shown in FIGS. 12A-D, more drones are launched simultaneously, in other embodiments, so long as initial flight paths 416, 418 do not conflict.

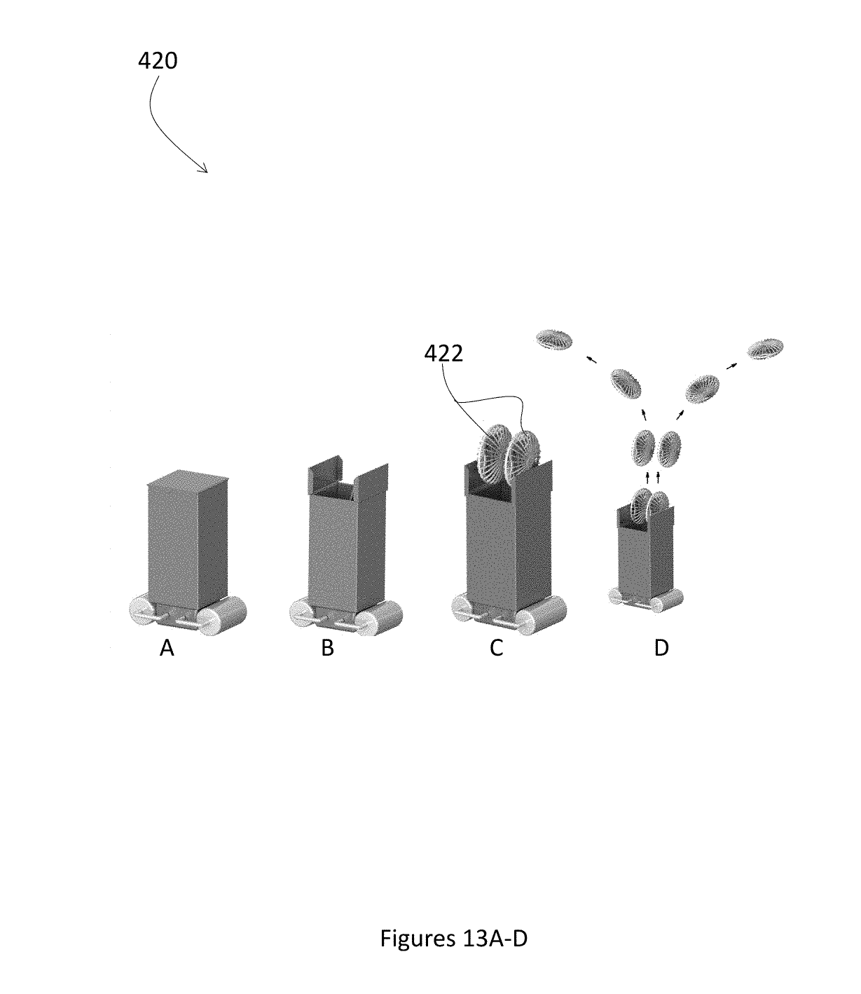

A further alternative embodiment 420 is depicted in FIGS. 13A-D. The deployment embodiment 420 is designed to launch a pair 422 of the alternative embodiment of the drones shown in FIG. 10.

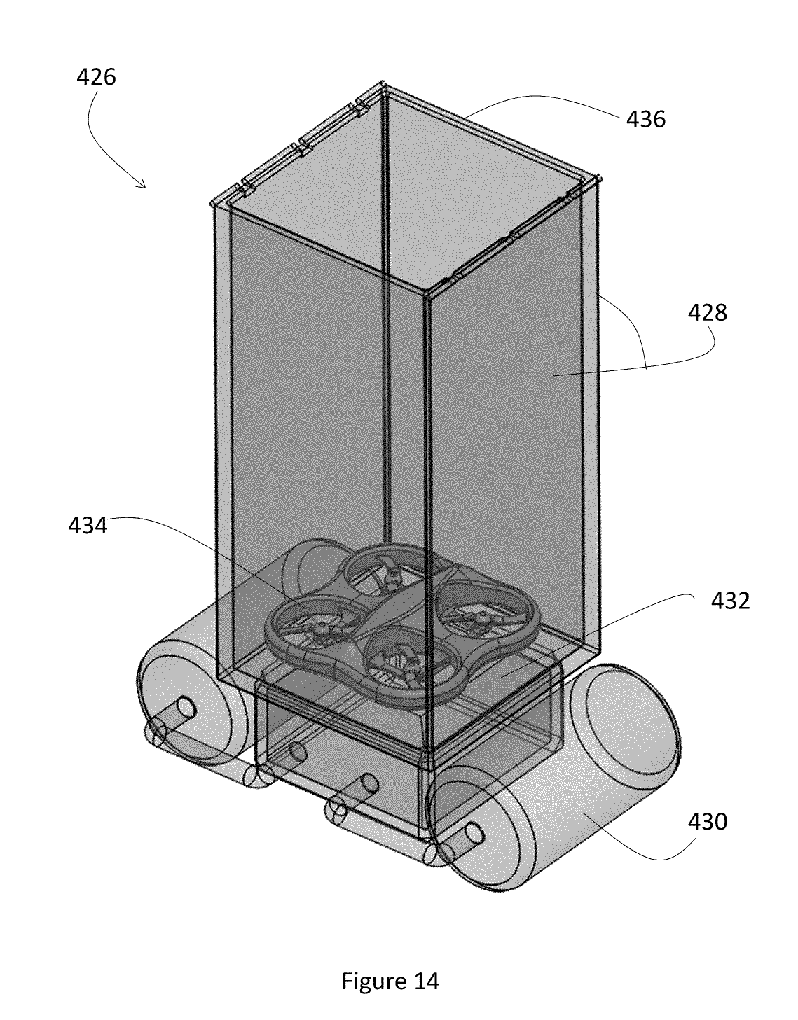

A detailed view of one container 426 is shown in FIG. 14. The container includes four sidewalls 428, wheels 430. In one embodiment, the container 426 includes a moveable platform 432 which moves and tilts a drone 434 which is initially removably attached to the platform 432. During the launch sequence, the platform 432 moves towards the open top 436 of the container 428. As the platform 432 approaches the top 436, the platform 432 pivots sideways to allow for the launch of the drone.

While a single drone is depicted in FIG. 14, in the multi drone environment, more than one platform 432 and more than one drone 434 is attached to the platform 432, including on opposing sides of the platform 432.

The movement of the platform 432 is accomplished using a hydraulic system. In another embodiment, not shown, the movement of the platform 432 occurs due to at least one rail built into the sidewall 428 of the container.

In another embodiment, the platform 432 is not movable and the drone 434 moves out of the container 426 using its own lifting force.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The embodiment of the invention in which an exclusive property or privilege is claimed is defined as follows:

1. A system for exchanging location-aware information comprising:
a server having a data store and an analytical engine;
at least one transmission point in communication with said server;
at least item beacon in communication with at least one transmission point wherein said item beacon includes a means to determine the location of said beacon; and
at least one end user device wherein said end user device is in communication with said server and displays information about item beacons received from the at least one transmission point.

2. The system of claim 1 wherein said transmission point comprises a solar-powered add-on to a light source.

3. The system of claim 1 wherein said beacon further comprises temperature, acceleration, and gravity sensors.

4. The system of claim 1 wherein said server sends alerts to said at least one end user device.

5. The system of claim 4 wherein said alerts comprise notification of theft of an item having a beacon attached thereto.

6. The system of claim 1 wherein said analytical engine sends a message to an end user as a target of said analytical engine message and contacts of said target user.

7. A system for exchanging location-aware information comprising:
at least one server having a data store and an analytical engine;
at least one mobile transmission point in communication with said server;
at least item beacon in communication with at least one transmission point wherein said item beacon includes a means to determine the location of said beacon; and
at least one end user device wherein said end user device is in communication with said server and displays information about item beacons received from the at least one transmission point.

8. The system of claim 7 wherein said mobile transmission point further comprises sensors and a rotor-based flying mechanism.

9. The system of claim 8 wherein said mobile transmission point traverses a path in three-dimensional space starting with a base station, followed by visiting a set of locations, and returning to the base station.

10. The system of claim 9 wherein said mobile transmission point set of locations is determined by an end user.

11. The system of claim 9 wherein said mobile transmission point set of locations is determined automatically.

12. The system of claim 9 wherein said set of locations comprise beacon locations and wherein individual beacons are added to the set of locations on basis of received sensor readings of said beacons.

13. The system of claim 12 wherein said received sensor readings further comprise alarm states of said beacons and wherein beacons are added to the set of locations based on priorities assigned to alarms.

14. The system of claim 6 wherein said contacts of said target user comprise social media contacts of said target user.

15. The system of claim 13 wherein said alarm states are communicated to said end user device.

16. The system of claim 15 further comprising communicating the alarm states to third parties affiliated with said end user device wherein said affiliation includes status as a contact within a social network.

17. The system of claim 1 wherein at least one of said beacons comprises at least one sensor and wherein said at least one sensor is removable.

18. The system of claim 7 wherein at least one of said beacons comprises at least one sensor and wherein said at least one sensor is removable.

19. The system of claim 7 further comprising a launching system for said mobile transmission point, said launching system comprising a container having an operable top, and a launching mechanism.

20. The system of claim 19 wherein said launching system comprises a container having two mobile transmission points, and a launching system for launching two mobile transmission points concurrently.
